(19) United States
(12) Patent Application Publication
(10) Pub. No.: US 2004/0247869 A1
(43) Pub. Date: Dec. 9, 2004

(54) Aluminum oxide coated fiber metal for S2S and S3S sealing system with extended oxidation life

(76) Inventors: Farshad Ghasripoor, Scotia, NY (US); Chek Beng Ng, Albany, NY (US); Raymond Edward Chupp, Glenville, NY (US); Jeffrey R. Thyssen, Delmar, NY (US); Don Mark Lipkin, Niskayuna, NY (US); Dalero W. Berkeley, Greenville, SC (US)

Correspondence Address: NIXON & VANDERHYE P.C./G.E., 1100 N. GLEBE RD., SUITE 800, ARLINGTON, VA, 22201, US

(21) Appl. No.: 10/452,056

(22) Filed: Jun. 3, 2003

(51) Int. Cl. B32B 15/04

(52) U.S. Cl. 428/375

(57) ABSTRACT

Oxidation resistant sealant system comprising a fiber metal component coated with an aluminum oxide layer.

The present invention relates to an oxidation resistant seal system, which provides better clearance control to reduce hot gas leakage, decrease heat rate and improve turbine efficiency in gas turbines. More specifically, the invention provides an aluminum oxide coated fiber metal seal system, particularly adapted for use as a gas path seal for Stage 2 and Stage 3 shrouds on E and F class gas turbines.

### BACKGROUND OF THE INVENTION

Currently, honeycomb seals are used in a number of different locations in gas turbines, for example in stages 2 and 3 of the 7E turbine against rails on shrouded buckets. Honeycomb is used as an abradable system whereby the rotating rails on the buckets may incur into them during any transient closures between the buckets and the shroud. The incursion into the honeycomb is a sacrificial form of sealing, as the intention is that there be no damage to the bucket rails during the interaction. However, the primary problem with honeycomb, particularly in stage 2 shrouds, is its low resistance to oxidation. The honeycomb material is typically 75Ni-16Cr-4.5Al-3Fe-0.05C-0.01Y-0.5Mn-0.2Si-0.1Zr-0.01B (Haynes 214). The temperature range in this location of the turbine is generally in the range of 1500-1700° F. At ˜1600° F., the oxidation life of a 0.005″ thick honeycomb is less than 20,000 hours.

In order to extend the oxidation life of Haynes 214 honeycomb, wall thickness has to be increased to between 0.008-0.011″. However, increasing the honeycomb wall thickness renders the honeycomb less abradable, thus increasing the risk of bucket rail damage during any transient rubs. Alternatively, use of other honeycomb materials such as oxide dispersion strengthened super alloys (e.g. FeCrAlY's) would create additional difficulties such as high costs and brittle behavior (loss of strength) at lower temperatures.

An alternative abradable sealing system currently in use in turbines, particularly gas turbines, consists of a known material called “fiber metal,” which is typically a FeCrAlY compound or Hastaloy-X. The fiber metal consists of micron size metal fibers sinter bonded into a continuous felt structure. The structure has a density range of between 10-50% and ultimate tensile strength of between 500-3000 psi. Because fiber metal is porous and directly exposed to the high temperature gases of the second and third stages, its oxidation life is limited.

A need exists for an oxidation protected fiber metal seal system which extends the life of the fiber metal while at the same time providing clearance control to reduce hot gas leakage, decreased heat rate and improved turbine efficiency. The present invention seeks to fill that need.

### BRIEF DESCRIPTION OF THE INVENTION

It has now been discovered surprisingly that it is possible to extend the oxidation life of a fiber metal sealing system by providing a thin protective aluminum oxide layer to coat the fiber metal. While enhancing the oxidation resistance of the fiber metal, the application of the protective aluminum oxide layer does not have an adverse effect on abradability and erosion.

According to one aspect, the present invention provides an oxidation resistant seal system comprising a fiber metal component coated with an aluminum oxide layer. According to another aspect, there is provided a method of extending the oxidation life of a fiber metal sealing system, comprising providing a thin protective aluminum oxide coating on the fiber metal.

Advantages of the high temperature sealing system of the invention are extended oxidation life, and no or minimal bucket/blade wear.

### DETAILED DESCRIPTION OF THE INVENTION

The present invention is based on the discovery that it is possible to take advantage of the inherent structural integrity of an existing sealing material, fiber metal, while bolstering the oxidation resistance of the substrate material by providing a coating of oxidation resistant Al₂O₃ on the surface of the fiber metal. This coating enhances the oxidation resistance, and hence the life of the sealing system, without compromising any of the other critical properties of the material.

The coating is applied to the fiber metal by conventional chemical vapor deposition (CVD). Alternatively, PVD (physical vapor deposition) may be employed, but is less preferred to CVD.

The alumina coating generally has a thickness of about 5 microns.

### EXAMPLES

The following test results illustrate how the presence of an alumina coating on the fiber metal improves the life of the fiber metal.

TABLE
Data Collected at 2000° F.

| | | | | Net | Net | | | Net | Net |
|---|---|---|---|---|---|---|---|---|---|
| | | | | Average | Average | | | Average | Average |
| Time/ | | | | Wt Gain | Wt | | | Wt Gain | Wt Gain |
| hours | A7 | A8 | A9 | (g) | Gain % | A10 | A11 | (g) | % |
| 0 | 15.2449 | 14.6648 | 14.8975 | 0.0000 | 0.0000 | 14.1323 | 14.3858 | 0.0000 | 0.0000 |
| 168 | 15.9515 | 15.3899 | 15.6251 | 0.7198 | 4.8191 | 14.9720 | 15.2274 | 0.8406 | 5.8956 |

Δ weight for each sample −0.70660 −0.72510 −0.72760 −0.83970 −0.84160
Note:
A7 through A9 = Fiber metal with CVD aluminum oxide
A10 through A11 = Fiber metal plain

As illustrated in the Table above, the life of the Al₂O₃ coated fiber metal is about 1.2 times longer than the fiber metal without Al₂O₃ coating after 168 hours at 2000° F.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An oxidation resistant seal system comprising a fiber metal component coated with an aluminum oxide layer by chemical vapor deposition or physical vapor deposition.

2. A system according to claim 1, wherein said aluminum oxide layer has a thickness of about 3-10 microns.

3. A system according to claim 1, wherein said aluminum oxide layer has a thickness of about 5 microns.

4. A system according to claim 1, wherein said component is adapted for use as a seal for Stage 2 and Stage 3 shrouds on E and F class gas turbines.

5. A method of extending the oxidation life of a fiber metal sealing system, comprising providing a thin protective aluminum oxide coating on said fiber metal by chemical vapor deposition or physical vapor deposition.

6. A method according to claim 4, wherein said protective aluminum coating has a thickness of about 3-10 microns.

7. A method according to claim 6, wherein said thickness is about 5 microns.
